(19) United States
(12) Patent Application Publication
(10) Pub. No.: US 2026/0180256 A1
(43) Pub. Date: Jun. 25, 2026

(54) HYBRID COMPRESSION COMPLIANT BOARD CONNECTOR INTERFACE

(71) Applicant: Molex, LLC, Lisle, IL (US)

(72) Inventors: Jack K. Armitage, Naperville, IL (US); Scott Edwards, Little Rock, AR (US); John C. Laurx, Aurora, IL (US); William J. Miller, II, New Lenox, IL (US)

(21) Appl. No.: 19/426,702

(22) Filed: Dec. 19, 2025

Related U.S. Application Data
(60) Provisional application No. 63/736,617, filed on Dec. 20, 2024.

(51) Int. Cl. H01R 13/6585; H01R 12/72; H01R 13/05

(52) U.S. Cl. CPC H01R 13/6585; H01R 12/722; H01R 13/05

(57) ABSTRACT

A connector that provides a solderless mating interface and includes ground shields with terminal pairs, a tail aligner with apertures, and a gasket with apertures. The connector has compression signal contacts coupled to the terminal pairs and compressible compliant pins integral with the ground shield. The compression signal contacts and compliant pins extend through the tail aligner and gasket apertures. The compliant pins may be eye-of-the-needle type and extend below the gasket and tail aligner. The ground shields may be nested within a connector housing. The connector provides a solderless, mechanically robust connection suitable for high-speed differential signaling applications.

### TECHNICAL FIELD

The present disclosure relates to electrical connectors and, more specifically, to an electrical connector that combines compression-based signal contacts with compliant ground pins for improved electrical performance and mechanical reliability.

### BACKGROUND

Modern electronic systems increasingly rely on high-speed differential signaling to transmit data at ever-higher rates while maintaining signal integrity. Differential signaling allows for faster communication between components, reduced electromagnetic interference, and improved noise immunity compared to single-ended signaling. As data rates continue to increase, the need for connectors capable of supporting these high-speed differential signals becomes important, particularly in applications where space is at a premium and signal density must be maximized.

However, implementing high-speed differential signaling in connectors presents several challenges. Board launch, the transition point where the connector meets the printed circuit board, is an important factor in providing optimal signaling, as any impedance mismatches or signal discontinuities at a board launch interface can significantly degrade signal integrity. Additionally, as pin counts increase and pitch decreases, traditional soldered connections become more difficult to inspect and verify, leading to potential reliability issues.

### BRIEF SUMMARY

According to an aspect of the present disclosure, a connector assembly system is provided. The system includes a connector adapted to couple to a substrate having a plurality of vias and a plurality of conductive pads. The connector includes a plurality of ground shields defining a plurality of U-shaped channels each having a terminal pair positioned therein. The connector further includes a conductive tail aligner comprising a plurality of tail aligner apertures, and a compressible conductive gasket comprising a plurality of gasket apertures. The connector also includes a plurality of compression signal contacts conductively coupled to the terminal pair configured to contact the plurality of conductive pads of the substrate. Additionally, the connector includes a plurality of compressible compliant pins integral with the ground shield configured to be positioned in the plurality of vias of the substrate. The plurality of compression signal contacts and the compressible compliant pins extend through respective ones of the tail aligner apertures and the gasket apertures, such that these components can be press fit on or otherwise mechanically coupled to the substrate.

The plurality of compression signal contacts can each be integral with a respective terminal of the terminal pair, and each of the plurality of compression signal contacts can include a bend separating a vertical portion from a cantilevered portion disposed at an angle relative to the vertical portion. For each of the plurality of compression signal contacts, the cantilevered portion can be angled relative to the vertical portion at an angle of between 75 to 110 degrees. The cantilevered portion may be sized and positioned to deflect relative to the vertical portion upon mating. At least one of the plurality of compressible compliant pins may be an eye-of-the-needle compressible compliant pin, and each of the plurality of vias of the substrate may define a seating depth that causes the plurality of compression signal contacts to deflect upon contact with the substrate. The bend of each of the plurality of compression signal contacts may be a coined portion.

A number of the plurality of compressible compliant pins may be at least two, and a first one of the plurality of compressible compliant pins may be disposed on a first side of each of the plurality of ground shields. A second one of the plurality of compressible compliant pins may be disposed on a second side of each of the plurality of ground shields. Alternatively, a number of the plurality of compressible compliant pins may be at least four, with a first one of the plurality of compressible compliant pins disposed on a first side of each of the plurality of ground shields, a second one of the plurality of compressible compliant pins disposed on a second side of each of the plurality of ground shields, and third and fourth ones of the plurality of compressible compliant pins disposed on a third side of each of the plurality of ground shields.

According to another aspect of the present disclosure, a connector is provided. The connector includes a plurality of ground shields, each of the plurality of ground shields having a terminal pair positioned therein. The connector also includes a gasket comprising a plurality of gasket apertures, a plurality of compression signal contacts conductively coupled to the terminal pair, and a plurality of compressible compliant pins integral with the ground shield. The plurality of compression signal contacts and the compressible compliant pins extend through respective ones of the gasket apertures.

The connector may further include a tail aligner comprising a plurality of tail aligner apertures, where the tail aligner is positioned below a housing of the connector and above the gasket. The plurality of tail aligner apertures can be aligned with the plurality of gasket apertures, and the plurality of compression signal contacts and the compressible compliant pins can extend through respective ones of the tail aligner apertures and the gasket apertures. Inner surfaces of the tail aligner apertures can be conductively plated, and the ground shields may be grounded to the tail aligner.

The plurality of compression signal contacts can each be integral with a respective terminal of the terminal pair, and each of the plurality of compression signal contacts can include a bend separating a vertical portion from a cantilevered portion disposed at an angle relative to the vertical portion. For each of the plurality of compression signal contacts, the cantilevered portion can be angled relative to the vertical portion at an angle of between 75 to 110 degrees. The cantilevered portion can be sized and positioned to flex relative to the vertical portion upon mating.

At least one of the plurality of compressible compliant pins can be an eye-of-the-needle compressible compliant pin. A number of the plurality of compressible compliant pins may be at least four, with a first one of the plurality of compressible compliant pins disposed on a first side of each of the plurality of ground shields, and a second one of the plurality of compressible compliant pins disposed on a second side of each of the plurality of ground shields. Third and fourth ones of the plurality of compressible compliant pins may be disposed on a third side of each of the plurality of ground shields.

The plurality of compressible compliant pins may extend below the gasket and the tail aligner, and the plurality of ground shields can be nested within a housing of the connector. The gasket can be formed of a conductive compressible foam material. The gasket can be impregnated with conductive material or may be conductively plated such that the gasket is conductive.

This summary is provided to introduce a selection of concepts in a simplified form that are further described below in the detailed description, and is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a connector assembly coupled to a substrate according to various embodiments of the present disclosure.

FIG. 2 is a bottom perspective view of the connector assembly coupled to the substrate according to various embodiments of the present disclosure.

FIG. 3 is another bottom perspective view of the connector assembly coupled to the substrate according to various embodiments of the present disclosure.

FIG. 4 is a bottom perspective view of the connector assembly with the substrate omitted according to various embodiments of the present disclosure.

FIG. 5 is a bottom perspective view of the connector assembly with a housing thereof omitted according to various embodiments of the present disclosure.

FIGS. 6 and 7 are enlarged views of a mating interface of the connector assembly according to various embodiments of the present disclosure.

FIGS. 8 and 9 are enlarged views of terminals of the connector assembly contacting pads of a substrate according to various embodiments of the present disclosure.

FIGS. 10 and 11 are enlarged views of a mating interface of the connector assembly according to various embodiments of the present disclosure.

FIGS. 12 and 13 are enlarged views of a mating interface of the connector assembly according to various embodiments of the present disclosure.

### DETAILED DESCRIPTION

The present disclosure relates to connectors featuring a compression compliant board connector interface for high-speed signaling and data communication. Surface mount soldered terminations, where connector terminals are soldered directly to the board, present challenges in high-density, high-speed applications. One significant issue is the complexity of inspecting solder joints to ensure quality. In many cases, this inspection process requires the use of X-ray technology to detect potential shorts and verify proper solder formation. However, the presence of metal shielding within the connector can complicate the X-ray inspection process, potentially obscuring critical areas and making it difficult to perform a comprehensive and true assessment of solder joints.

Furthermore, if problems are identified during the inspection process, addressing these issues may involve subjecting the connector or the board to additional thermal stress. Removing and replacing a connector that has been soldered to the board typically requires another heat cycle, which can potentially impact the reliability of other components on the connector or the board itself. This rework process can be time-consuming, costly, and may introduce new variables that could affect the overall performance and longevity of an electronic system that incorporates the connector and the board.

As such, it can be beneficial to have a connector that implements a mechanical, solderless, press-fit connection to the board. By eliminating the need for solder, the connector does not require an inspection process as there are no solder joints to examine. This can reduce or eliminate the need for complex X-ray inspection. The ability to visually confirm proper seating and engagement of the connector can lead to faster, more reliable quality assurance processes. However, mechanical connections are difficult in high-density, high-speed applications, especially those that utilize differential pair signaling, thus soldered connections are sometimes preferable.

Accordingly, various embodiments are described for a solderless surface mount interface for use in high-speed, high-density applications including, but not limited to, those that implement differential signaling. A connector that incorporates the solderless interface reduces or eliminates impedance mismatches and signal discontinuities, which is beneficial for maintaining signal quality in high-speed differential signaling applications. Moreover, a mechanical press-fit connection offered by the solderless interface provides consistent electrical and mechanical performance across multiple mating cycles, which is beneficial in applications where connectors are removed and reseated multiple times during a product lifecycle.

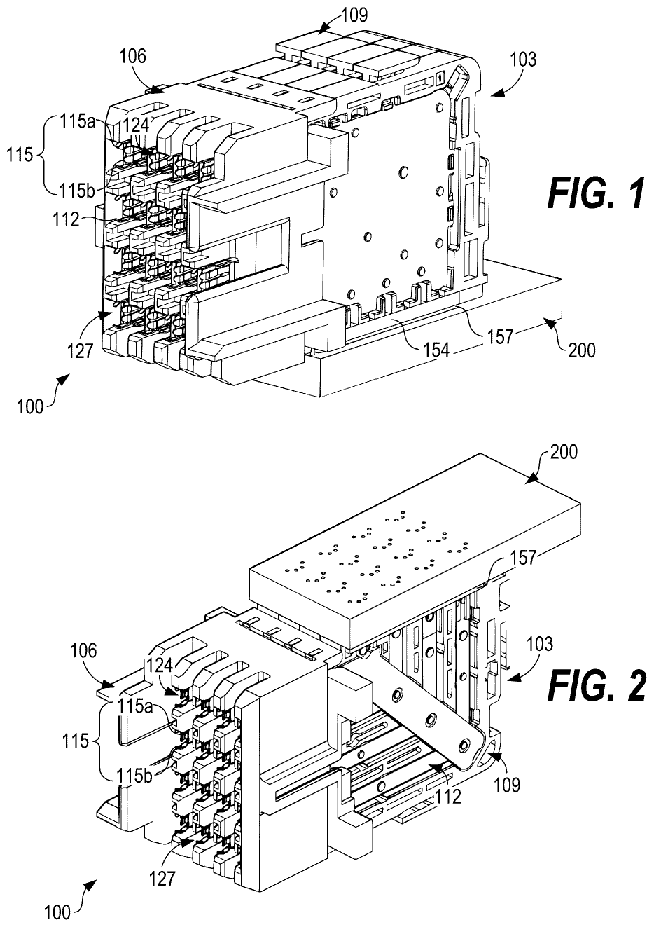

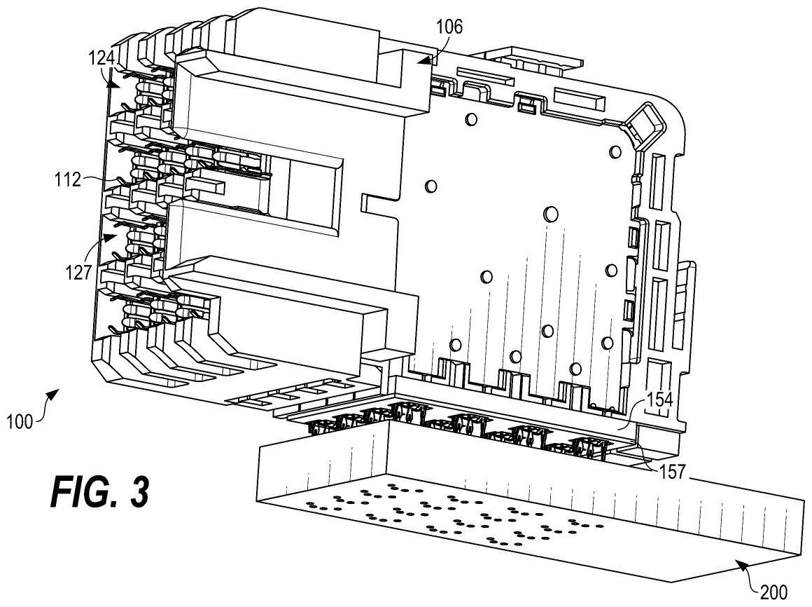

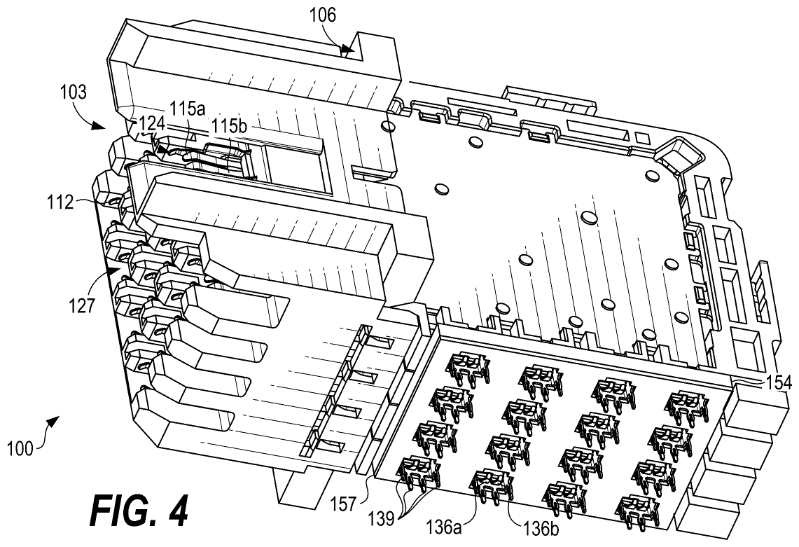

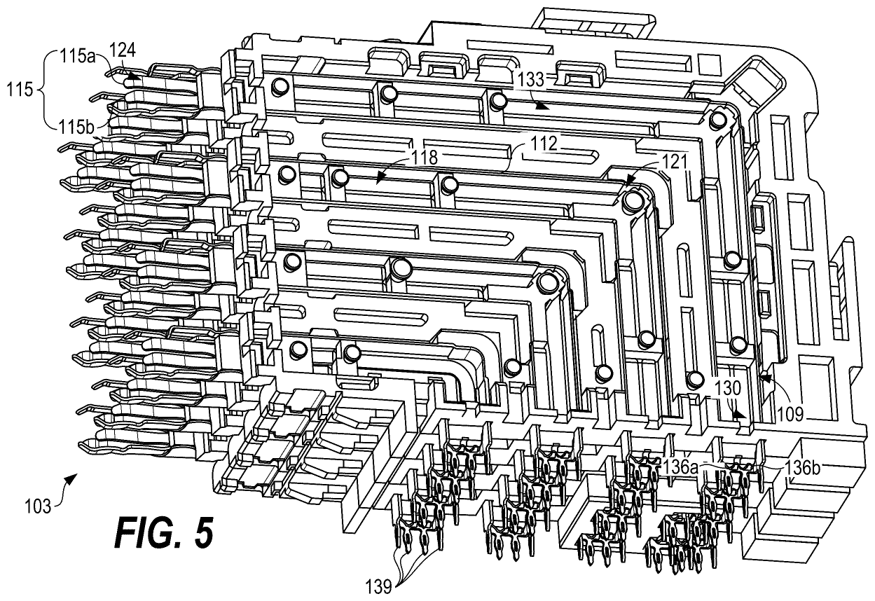

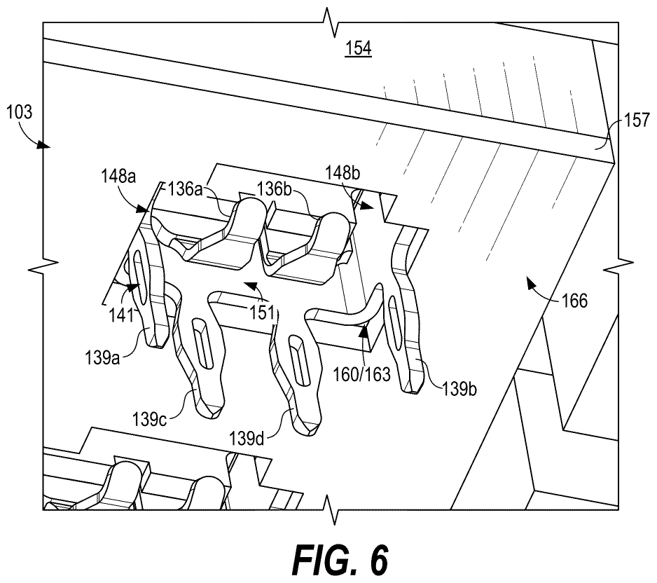

Turning now to the drawings, FIG. 1 is a top perspective view of a connector assembly 100 mechanically coupled to a substrate 200 according to various embodiments. FIGS. 2 and 3 are bottom perspective views of the connector assembly 100 and the substrate 200 of FIG. 1. FIG. 4 is a bottom perspective view of the connector assembly 100 with the substrate 200 omitted for explanatory purposes. FIG. 5 is a bottom perspective view of the connector assembly 100 with the substrate 200 and a connector housing omitted.

Referring to FIGS. 1-5 collectively, the connector assembly 100 includes a connector 103, which can include a daughtercard connector according to various embodiments. To this end, the connector assembly 100 can connect a first printed circuit board (e.g., a daughtercard) to a second printed circuit board (e.g., a motherboard). Thus, the connector assembly 100 can be a board-to-board connector in some implementations. The daughtercard configuration of the connector 103 as illustrated is a right-angle connector, however, other configurations of connectors can be employed, such as vertical, straddle-mount, and so forth. In some embodiments, the connector 103 can be another type of connector including, but not limited to, a wire-to-board connector, a board-to-wire connector, and so on.

The connector 103 can include a connector housing 106, which can be referred to herein generally as the housing 106 for short. The housing 106 can be formed of various materials and through different manufacturing processes. In some embodiments, the housing 106 can be injection molded using a plastic or polymer, such as polyamide (nylon), polycarbonate (PC), liquid crystal polymer (LCP), polyethylene (PE), polytetrafluoroethylene (PTFE), polybutylene terephthalate (PBT), polyphenylene sulfide (PPS), fluoropolymer, or other plastic or insulating material(s). However, in other embodiments, the housing 106 can be formed through compression molding, transfer molding, machining, or other like processes. The housing 106 can be constructed from multiple components that are assembled together, or can include a single integrally molded construction.

The housing 106 can retain and support a multitude of terminal assemblies 109. Each of the terminal assemblies 109 can form a row or a column of high-speed signaling terminals in the connector 103. In some embodiments, the terminal assemblies 109 can be arranged in a grid pattern based on arranging multiple terminal assemblies 109 side-by-side to maximize density, thereby forming various rows and columns of conductive terminals.

Each of the terminal assemblies 109 can include one or more ground shields 112 and one or more conductive terminals. For instance, the one or more conductive terminals can include terminal pairs 115. The terminal pairs 115 can include a first terminal 115a and a second terminal 115b for differential signaling. In some implementations, the first and second terminals 115a, 115b can be configured to carry complementary or differential signals. The ground shields 112 thus can help isolate the terminal pairs 115 from electromagnetic interference. The spacing and geometry of the terminal pairs 115 can maintain signal integrity at frequencies exceeding several gigahertz. For instance, the terminal pairs 115 can be optimized for high-speed data transmission, with controlled impedance and minimal crosstalk between adjacent terminal pairs 115.

In some embodiments, each of the ground shields 112 can include three side surfaces that collectively define a channel or, more specifically, a U-shaped channel 118. For instance, a first bend can side a first side surface, a second bend can define a second side surface, and a third side can be positioned between the first bend and the second bend, which can be a bottom surface of the U-shaped channel 118. Each terminal pair 115 can be positioned in a respective one of the U-shaped channels 118. In implementations in which the connector 103 is a right-angle connector, the terminal pairs 115 can incorporate a bend 121 (e.g., a right-angle bend) that separates a horizontal portion from a vertical portion of each terminal. The horizontal portion can extend parallel to a surface of the substrate 200, facilitating connection to circuit board traces, while the vertical portion can rise perpendicular to the substrate 200. The vertical portion of the terminal pairs 115 can extend beyond the housing 106, facilitating a mechanical connection with the substrate 200, as will be described.

The ground shields 112 (and the U-shaped channels 118) can include a similar bend such that signal reflections are minimized and consistent impedance is provided through the transition from horizontal to vertical. The specific dimensions and geometry of the horizontal and vertical portions can be optimized based on factors such as signal frequency, desired impedance, and space constraints within the connector assembly 100.

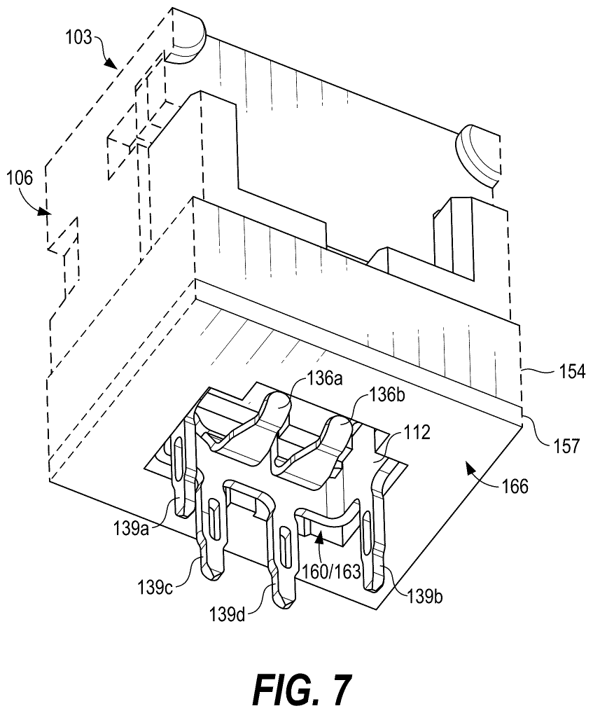

In the particular embodiments shown in FIGS. 1-5, each terminal of the terminal pairs 115 can include a mating end 124 positioned through a front opening 127 in the housing 106 for mating to an external board or connector (not shown), a tail end 130 positioned through apertures on a bottom of the housing 106, and a body section 133 extending between the mating ends 124 and the tail ends 130. FIG. 6 shows an enlarged view of a bottom portion of the connector 103. The connector 103 can attach to the substrate 200 through a combination of mechanical and electrical interfaces without requiring the use of solder. As such, an individual or a robot can align the connector 103 with the substrate 200 and apply opposing forces to couple the connector 103 to the substrate 200, which then forms a connection therebetween.

In some embodiments, the connector 103 includes compression signal contacts 136 and compressible compliant pins 139. Like terminal pairs 115, the compression signal contacts 136 can be grouped in pairs that include a first compression signal contact 136a and a second compression signal contact 136b (or a pair of compression signal contacts 136). The first compression signal contact 136a can be electrically coupled to a first terminal 112a, and the second compression signal contact 136b can be electrically coupled to a second terminal 112b.

In some embodiments, the first compression signal contact 136a is integral with the first terminal 112a, and the second compression signal contact 136b is integral with the second terminal 112b. As such, the terminal pairs 115 and the compression signal contacts 136 can be formed of a common sheet of conductive material (e.g., aluminum or other conductive metal), which can be stamped, sheered, or otherwise cut and bent to form the terminal pairs 115 and the compression signal contacts 136. Notably, the compression signal contacts 136 do not require a minimum via size for mechanical engagement (such as that required for a compressible compliant pin 139) and, therefore, the compression signal contacts 136 allow for an optimized via launch internal to the substrate 200.

The compressible compliant pins 139 can include a multitude of compressible compliant pins (e.g., 139a . . . 139d) (collectively “compressible compliant pins 139”). The compressible compliant pins 139 can include a deformable body that deform and expand when positioned in a via or a through-hole of the substrate 200, thereby forming an interference or friction fit with the via or like aperture. To this end, the compressible compliant pins 139 can include eye-of-the-needle type pins, which is a type of press-fit pin having an elongated aperture 141 positioned in the body that permits the body to slightly deform upon insertion into a via or a through-hole. When positioned in the via, the biased shape and material of the compressible compliant pin 139 causes expansion, creating an interference and/or friction fit with the via. As the compressible compliant pins 139 are conductive, they can interface with conductive traces in the via.

In the examples of FIGS. 1-6, the conductive traces in the via can be ground traces, further facilitating grounding of the connector 103. Thus, the compressible compliant pins 139 can be referred to as ground pins in some embodiments. The compressible compliant pins 139 can be conductively coupled to respective ground shields 112 to provide a common ground path upon connection with the substrate 200. In some embodiments, the compressible compliant pins 139 are integral with the ground shields 112 and, thus, the compressible compliant pins 139 and the ground shields 112 can be formed of a common piece of metal or other conductive material.

In the embodiment of FIG. 6, a number of the compressible compliant pins 139 is four, but it is understood that other number of compressible compliant pins 139 can be employed, such as one, two, three, five, six, and so on. For example, in embodiments in which there are two compressible compliant pins 139, a first compressible compliant pin 139a can be disposed on a first side 148a of each of the ground shields 112 and a second compressible compliant pin 139b can be disposed on a second side 148b of each of the ground shields 112. In embodiments in which there are four compressible compliant pins 139a . . . 139d, a first compressible compliant pin 139a can be disposed on a first side 148a of each of the ground shields 112, a second compressible compliant pin 139b can be disposed on a second side 148b of each of the ground shields 112a, and a third compressible compliant pin 139c and a fourth one compressible compliant pin 139d can be disposed on a third side 151 of each of the ground shields 112. The compressible complaint pins 139 can extend off a bottom face of each of the ground shields 112. The compression signal contacts 136 are thus positioned within an arrangement of the compressible compliant pins 139, which can ensure desired grounding and signal integrity.

As shown in FIG. 7, a sectional view of the connector 103 is shown according to various embodiments. It is understood that a multitude of the sections of FIG. 7 can be combined to form the connector 103 shown in FIG. 1, for example. The connector 103 can include a tail aligner 154 and a gasket 157. The tail aligner 154 can be positioned below the housing 106, and the gasket 157 can be positioned below the tail aligner 154. In other words, the tail aligner 154 can be positioned between the housing 106 and the gasket 157. The compressible compliant pins 139 extend below the gasket 157 and the tail aligner 154, and the ground shields 112 are shown as being nested within the housing 106 of the connector 103.

The tail aligner 154 can include a generally rigid structure to support various connection components of the connector 103. The tail aligner 154 includes tail aligner apertures 160 (or apertures 160) in alignment with the ground shields 112 and the terminal pairs 115. Thus, the ground shields 112 and the terminal pairs 115 can extend through a bottom of the housing 106 into the tail aligner 154, where the tail aligner 154 provides rigidity and support to the plurality of ground shields 112 and the plurality of terminal pairs 115. Like the housing 106, the tail aligner 154 can be formed of a polymer material. Moreover, in some embodiments, the tail aligner 154 can be conductive. For instance, inner surfaces of the tail aligner apertures 160 of the tail aligner 154 can be selectively plated with a conductive material to provide enhanced grounding. The conductive material can include, but is not limited to, copper, aluminum, gold, and silver. Alternatively, conductive inserts (e.g., metal inserts) can be positioned within the tail aligner apertures 160, which can be formed of a polymer material. The ground shields 112 can contact inner surfaces of the apertures 160, which can further facilitate grounding.

The gasket 157 likewise includes gasket apertures 163 that are in alignment with the tail aligner apertures 160, thereby providing channels through which the mechanical and electrical components of the connector 103 can extend. For instance, the compression signal contacts 136 and the compressible compliant pins 139 can extend through respective ones of the tail aligner apertures 160 and the gasket apertures 163 such that the compression signal contacts 136 and the compressible compliant pins 139 can mate with conductive pads and vias of the substrate 200, respectively. The compression signal contacts 136 and the compressible compliant pins 139 thus can project from and extend below a bottom surface 166 of the gasket 157. Alternatively, in some implementations, the compression signal contacts 136 can be flush with the gasket 157 or can be positioned above the gasket 157, depending upon compression properties of the gasket 157. For instance, the gasket 157 can compress to an extent that permits the compression signal contacts 136 positioned flush with the gasket 157 or above the gasket 157 to contact pads on the substrate 200 without having to extend through the gasket apertures 163. In some embodiments, the tail aligner 154 is not provided, and the connector 103 includes only the gasket 157.

The material from which the gasket 157 is formed can be elastic and compressible to some extent. As an example, the gasket 157 can be embodied as a polyurethane foam multi-laminate including conductive materials, such as copper, nickel, or other conductive metals or materials. In a particular example, the gasket 157 can be embodied as the P-SHIELD® brand PS-1323, PS-1768, or similar conductive foam, foam tape, or foam sheet manufactured by Polymer Science, Inc. of Monticello, Indiana, although other suitable types of conductive elastomeric or foam materials can be relied upon. The gasket 157 can range in thickness from between 0.1-1.0 mm, and example thicknesses include 0.1 mm, 0.2 mm, 0.3 mm, 0.4 mm, 0.5 mm, 0.6 mm, 0.7 mm, 0.8 mm, 0.9 mm, 1.0 mm, and other thicknesses can be relied upon. In another example, the conductive foam inlays can range in thickness from between 0.5-2.0 mm, and example thicknesses include 0.5 mm, 1.0 mm, 1.5 mm, and 2.0 mm, and other thicknesses can be relied upon.

As such, according to various embodiments, the gasket 157 can be compressible and can thus be formed of an open-cell foam material. Like the tail aligner 154, the gasket 157 can be conductive. To provide conductivity, the gasket 157, as formed, can be impregnated with conductive particles, selectively plated with a conductive material, and so forth. To this end, in some embodiments, the gasket 157 can include one that provides conductivity along at least one of its width, height, and depth.

The gasket 157 can connect signal components of the connector 103 to an exposed conductive ground surface on the top of the substrate 200. The arrangement of the gasket 157 and the tail aligner 154 as conductively provided can help optimize a common return path to enhance signal integrity and signal launch by reducing crosstalk. Thus, the tail aligner 154 and gasket 157 can work together to provide mechanical support and electrical continuity between the connector 103 and the substrate 200. As some embodiments include the gasket 157 being formed of a foam or elastomeric material, the gasket 157 can be press-fit to conform to surface irregularities, further enhancing the electrical connection. The combination of the tail aligner 154 and gasket 157 can contribute to maintaining consistent signal integrity across multiple mating cycles.

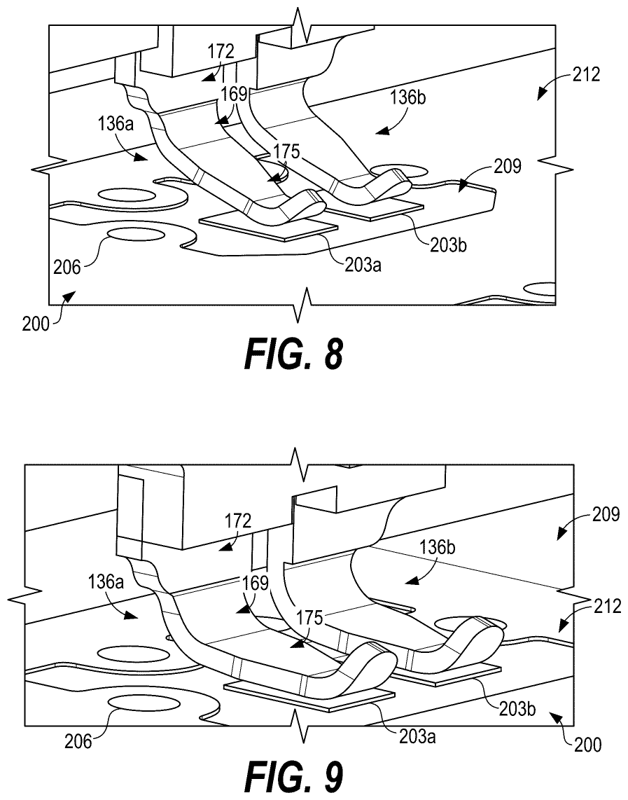

Turning now to FIGS. 8-9, enlarged views of the compression signal contacts 136 are shown relative to the substrate 200. The substrate 200 can include a printed circuit board (PCB) or like device that provides a platform for mounting and interconnecting various electronic components. In some aspects, the substrate 200 can be formed of a multitude of layers with conductive traces on different layers to provide a complex routing of signals. The substrate 200 can include vias 206, which can be plated through-holes that provide electrical connections between different layers of the substrate 200.

Additionally, the substrate 200 can include various conductive pads 203a, 203b (collectively “conductive pads 203”) positioned on its top surface 209 that are conductively coupled to various traces disposed in various layers of the substrate 200. The conductive pads 203 can serve as landing areas for the compression signal contacts 136 of the connector 103. The conductive pads 203 can be part of a larger conductive region 212 positioned on a top surface 209 of the substrate 200 in some embodiments. The arrangement and dimensions of the vias 206 and conductive pads 203 on the substrate 200 can be designed to match the arrangement of the connector 103, ensuring proper alignment and electrical contact when the connector 103 is mounted to the substrate 200.

Specifically, as the connector 103 is affixed to the substrate 200 during a connector seating process, FIG. 8 shows the start of a “wipe” where the compression signal contacts 136 begin making contact with corresponding ones of the conductive pads 203 positioned on the top surface 209 of the substrate 200. FIG. 9 shows further seating between the connector 103 and the substrate 200, where the compression signal contacts 136 continue to wipe or transition along an upper surface of the conductive pads 203. Notably, the compression signal contacts 136 deform or flex, which causes a substantial portion of the compression signal contacts 136 to make contact with the conductive pads 203, ensuring a quality connection therebetween.

More specifically, each of the compression signal contacts 136 can include a bend 169 that defines a vertical portion 172 and a cantilevered portion 175 of a compression signal contacts 136. The cantilevered portion 175 can be cantilevered or fixed at one end with respect to the vertical portion 172 and can be angled relative to the vertical portion 172. For instance, the cantilevered portion 175 can be angled relative to the vertical portion 172 approximately 75 to 110 degrees, as shown in FIG. 8, based on a degree of the bend 169. The cantilevered portion 175 can flex upon contact with the substrate 200 to be approximately 80 to 115 degrees relative to the vertical portion 172, ensuring a predetermined amount of contact between a bottom surface of the cantilevered portion 175 and the conductive pads 203. The vertical portions 172 can extend to and can be integral with terminals of the terminal pairs 115.

According to various embodiments, the bend 169 in the compression signal contacts 136 may be formed through a coining process, which can include applying localized pressure to the terminal material to create a precise and controlled deformation. Coining can produce a more uniform and repeatable bend compared to traditional bending methods. The coining process thus can include using various dies or tools to compress and shape the terminal material at the desired location, resulting in the bend 169 that separates the vertical portion 172 from the cantilevered portion 175. The coining process can permit precise control over the angle between the vertical portion 172 and the cantilevered portion 175, which may be beneficial for maintaining optimal contact force and ensuring reliable electrical connections with the conductive pads 203 on the substrate 200. While only bend 169 is disclosed, it is understood that each of the compression signal contacts 136 can be formed using multiple bends, as can be appreciated.

As can be seen in FIGS. 8 and 9, compression signal termination is achieved with the compression signal contacts 136 acting as cantilevered beams which contact the conductive pads 203 on the substrate 200 and which are deflected during a connector seating process to generate sufficient normal force for a reliable termination. In some embodiments, the compression signal contacts 136 are sized and positioned to provide a reliable electrical connection while allowing for some degree of compliance to accommodate manufacturing tolerances.

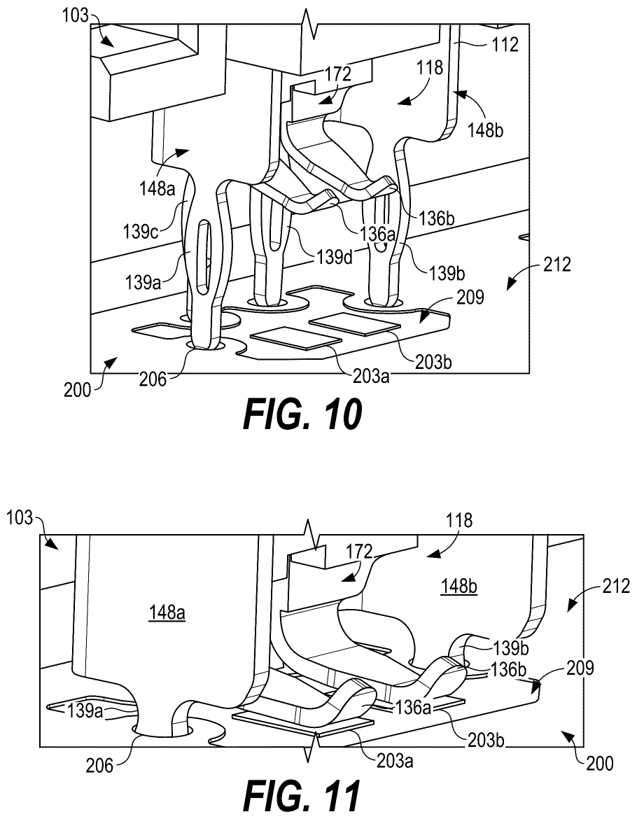

Moving along to FIGS. 10 and 11, enlarged views of the compression signal contacts 136 and the compressible compliant pins 139 are shown relative to the substrate 200, where the substrate 200 can include a printed circuit board in some embodiments. The gasket 157 is omitted from FIGS. 10 and 11 for explanatory purposes. The compressible compliant pins 139 can provide both mechanical stability and electrical grounding. FIG. 10 shows the start of a connector seating process where the compressible compliant pins 139 are positioned in vias 206 located on a surface 209 of the substrate 200, and FIG. 11 shows the end of the connector seating process where the compressible compliant pins 139 are fully positioned in the vias 206 and the compression signal contacts 136 are deflected and positioned on the conductive pads 203 to maximize the area the compression signal contacts 136 rest on the conduct pads 203.

In FIG. 10, the compressible compliant pins 139 are shown aligned with the vias 206 of the substrate 200 for insertion and coupling to the substrate 200. The compression signal contacts 136 are positioned above the conductive pads 203, not yet making contact. The compressible compliant pins 139 may act as guide features on the connector 103 that ensure precise positioning before the seating process begins.

FIG. 11 illustrates the fully seated configuration. The compressible compliant pins 139 are fully inserted into the vias 206, where they may expand slightly to create a secure mechanical and electrical connection. The compression signal contacts 136 are shown in a deflected state, with the cantilevered portions 175 flexed upward relative to their initial position. This deflection may create a biased or spring force that ensures consistent contact pressure against the conductive pads 203.

The vias 206 of the substrate 200 may be designed to accommodate a specific seating depth of the compressible compliant pins 139. This seating depth may be optimized to ensure proper engagement of the compressible compliant pins 139 while also facilitating the desired deflection of the compression signal contacts 136. The seating depth may vary depending on factors such as the overall height of the connector 103, the length of the compressible compliant pins 139, and the desired contact force for the compression signal contacts 136. In some embodiments, the seating depth may be designed to allow the compressible compliant pins 139 to be fully inserted into the vias 206 while leaving sufficient space for the compression signal contacts 136 to make proper contact with the conductive pads 203 on the surface 209 of the substrate 200.

A deeper seating depth may provide more secure mechanical retention of the connector 103 to the substrate 200 through the compressible compliant pins 139. However, it may also result in greater deflection of the compression signal contacts 136, potentially increasing contact force but also potentially introducing more stress on these components. Conversely, a shallower seating depth can reduce the deflection of the compression signal contacts 136, extending their lifespan with a tradeoff of reduced contact force. In some implementations, the seating depth may be designed to achieve an optimal balance between these factors, ensuring reliable electrical connections and mechanical stability while minimizing wear on the connector components. Moreover, the connector 100 can provide approximately 60-75 grams force per contact and can travel 0.2 mm to 1.5 mm, although other grams force per contact and other travel distances can be achieved.

Moreover, the seating depth of the vias 206 can be optimized based on a type of the compressible compliant pins 139. For instance, eye-of-the-needle style pins may require a certain minimum depth to achieve proper expansion, retention, and grounding within the via 206. It is understood that the substrate 200 can include depth-limiting features, such as shoulders or steps within the vias 206, to control the seating depth of the compressible compliant pins 139, which can help ensure consistent seating across multiple connectors 103 or multiple installations of the same connector 103.

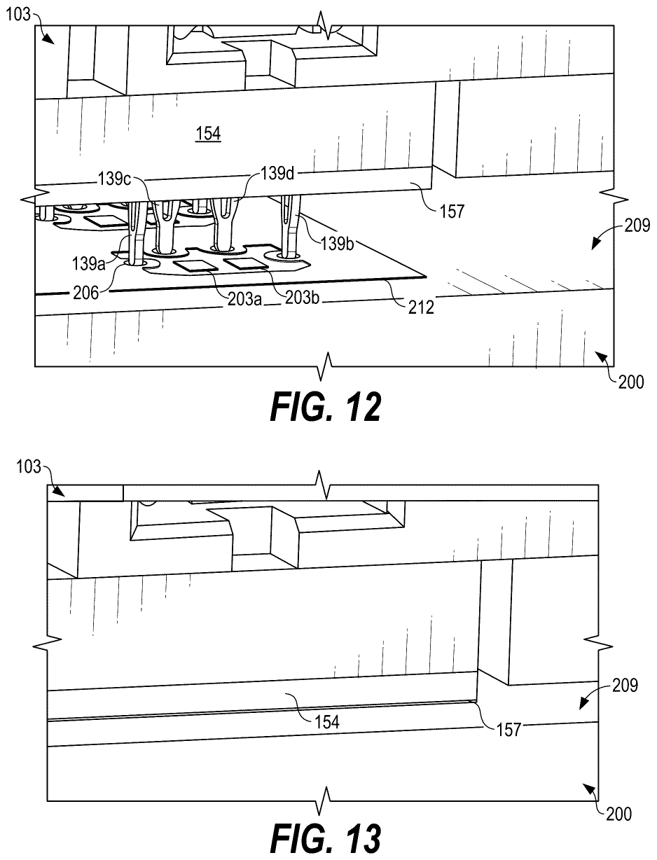

The transition from FIG. 12 to FIG. 13 may involve a controlled insertion process, where the connector 103 is pressed onto the substrate 200 with a specific force or to a predetermined depth. During the seating process, the compressible compliant pins 139 may deform slightly as they enter the vias 206, creating an interference or friction fit that helps retain the connector 103 on the substrate 200. Simultaneously, the compression signal contacts 136 may undergo a sliding or wiping motion across the surface of the conductive pads 203 causing a deflection, ensuring an optimal wipe with the conductive pads 203.

In some implementations, the fully seated configuration shown in FIG. 12 may result in the gasket 157 being compressed against the surface of the substrate 200, providing additional sealing and enhancing the ground connection between the connector 103 and the substrate 200. The tail aligner 154, if present, can help maintain the relative positions of the compression signal contacts 136 and compressible compliant pins 139 during the seating process, ensuring consistent contact patterns across multiple connector installations.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” “third,” etc. are used only as labels, rather than a limitation for a number of the objects. It is understood that if multiple components are shown, the components may be referred to as a “first” component, a “second” component, a “third components,” and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A connector system, comprising:
a substrate comprising a plurality of vias and a plurality of conductive pads; and
a connector, comprising:
a plurality of ground shields defining a plurality of channels each having a terminal pair positioned therein;
a conductive tail aligner comprising a plurality of tail aligner apertures;
a compressible conductive gasket comprising a plurality of gasket apertures;
a plurality of compression signal contacts conductively coupled to the terminal pair and configured to contact the plurality of conductive pads of the substrate; and
a plurality of compressible compliant pins integral with the plurality of ground shields and configured to be positioned in the plurality of vias of the substrate, wherein the plurality of compression signal contacts and the plurality of compressible compliant pins extend through respective ones of the tail aligner apertures and the gasket apertures.

2. The connector system according to claim 1, wherein the plurality of compression signal contacts are each integral with a respective terminal of the terminal pair, and each of the plurality of compression signal contacts comprises a bend separating a vertical portion from a cantilevered portion disposed at an angle relative to the vertical portion.

3. The connector system according to claim 2, wherein, for each of the plurality of compression signal contacts, the cantilevered portion is angled relative to the vertical portion at an angle between 75 to 110 degrees.

4. The connector system according to claim 2, wherein the cantilevered portion is sized and positioned to deflect relative to the vertical portion upon mating.

5. The connector system according to claim 1, wherein at least one of the plurality of compressible compliant pins is an eye-of-the-needle compressible compliant pin, and each of the plurality of vias of the substrate define a seating depth that causes the plurality of compression signal contacts to deflect upon contact with the substrate.

6. The connector system according to claim 2, wherein the bend of each of the plurality of compression signal contacts is a coined portion.

7. The connector system according to claim 1, wherein, for each ground shield in the plurality of ground shields:
a number of the plurality of compressible compliant pins is at least two; and
a first one of the plurality of compressible compliant pins is disposed on a first side of each of the plurality of ground shields, and a second one of the plurality of compressible compliant pins is disposed on a second side of each of the plurality of ground shields.

8. The connector system according to claim 1, wherein, for each ground shield in the plurality of ground shields:
a number of the plurality of compressible compliant pins is at least four;
a first one of the plurality of compressible compliant pins is disposed on a first side of each of the plurality of ground shields, and a second one of the plurality of compressible compliant pins is disposed on a second side of each of the plurality of ground shields; and
third and fourth ones of the plurality of compressible compliant pins are disposed on a third side of each of the plurality of ground shields.

9. A connector, comprising:
a plurality of ground shields, each of the plurality of ground shields having a terminal pair positioned therein;
a gasket comprising a plurality of gasket apertures;
a plurality of compression signal contacts conductively coupled to the terminal pair; and
a plurality of compressible compliant pins conductively coupled to the plurality of ground shields, wherein the plurality of compression signal contacts and the plurality of compressible compliant pins extend through respective ones of the gasket apertures.

10. The connector according to claim 9, further comprising a tail aligner comprising a plurality of tail aligner apertures, wherein the tail aligner is positioned below a housing of the connector and above the gasket, the plurality of tail aligner apertures are aligned with the plurality of gasket apertures, and the plurality of compression signal contacts and the plurality of compressible compliant pins extend through respective ones of the tail aligner apertures and the gasket apertures.

11. The connector according to claim 10, wherein inner surfaces of the tail aligner apertures are conductively plated, and the ground shields are grounded to the tail aligner.

12. The connector according to claim 9, wherein the plurality of compression signal contacts are each integral with a respective terminal of the terminal pair, and each of the plurality of compression signal contacts comprises a bend separating a vertical portion from a cantilevered portion disposed at an angle relative to the vertical portion.

13. The connector according to claim 12, wherein, for each of the plurality of compression signal contacts, the cantilevered portion is angled relative to the vertical portion at an angle between 75 to 110 degrees.

14. The connector according to claim 12, wherein the cantilevered portion is sized and positioned to flex relative to the vertical portion upon mating.

15. The connector according to claim 9, wherein at least one of the plurality of compressible compliant pins is an eye-of-the-needle compressible compliant pin.

16. The connector according to claim 9, wherein, for each ground shield in the plurality of ground shields:
a number of the plurality of compressible compliant pins is at least two; and
a first one of the plurality of compressible compliant pins is disposed on a first side of each of the plurality of ground shields, and a second one of the plurality of compressible compliant pins is disposed on a second side of each of the plurality of ground shields.

17. The connector according to claim 16, wherein:
the number of the plurality of compressible compliant pins is at least four; and
third and fourth ones of the plurality of compressible compliant pins are disposed on a third side of each of the plurality of ground shields.

18. The connector according to claim 10, wherein the plurality of compressible compliant pins extend below the gasket and the tail aligner, and the plurality of ground shields are nested within the housing of the connector.

19. The connector according to claim 9, wherein the gasket is formed of a conductive compressible foam material.

20. The connector according to claim 9, wherein the gasket is impregnated with conductive material or is conductively plated such that the gasket is conductive.
